(19) United States
(12) Patent Application Publication
(10) Pub. No.: US 2018/0123871 A1
(43) Pub. Date: May 3, 2018

(54) INFORMATION PROCESSING DEVICE, REPEATING DEVICE, INFORMATION PROCESSING SYSTEM AND METHOD, AND PROGRAM

(71) Applicant: NEC CORPORATION, Tokyo (JP)

(72) Inventors: Shinichi ANAMI, Tokyo (JP); Youichi HIDAKA, Tokyo (JP)

(73) Assignee: NEC CORPORATION, Tokyo (JP)

(21) Appl. No.: 15/559,527

(22) PCT Filed: Mar. 14, 2016
(86) PCT No.: PCT/JP2016/057926

§ 371 Date: Sep. 19, 2017

(30) Foreign Application Priority Data
Mar. 23, 2015 (JP) 2015-059360

(51) Int. Cl. H04L 12/24; H04L 12/26; H04L 29/14; H04L 12/707

(52) U.S. Cl. CPC H04L 41/0668; H04L 43/065; H04L 41/12; H04L 69/40; H04L 45/22; H04L 43/0817

(57) ABSTRACT

An information processing device includes a failure determination unit which determines whether or not a failure has occurred in the information processing device configured to perform predetermined processing on the basis of information obtained from a state information acquisition device, and a processing destination determination unit which determines, when the failure has occurred, that a sub-processing device connected to a network is a processing destination that performs the predetermined processing. The failure determination unit may also determine whether or not a failure has occurred in another information processing device configured to perform predetermined processing on the basis of information obtained from the state information acquisition device.

### TECHNICAL FIELD

The present invention relates to an information processing device, a repeating device, an information processing system and method, and a program.

### BACKGROUND ART

The number of devices which store or detect various data is increasing around us with the spread of technologies associated with the Internet of Things (IoT). A cloud server which acquires information from a number of such devices and performs predetermined processing is being considered. However, the amount of information processing of the cloud server increases as the number of such devices increases. Reference can be made to Patent Document 1 as a relevant technology for transmitting data to the cloud server.

### PRIOR ART DOCUMENT

### Patent Document

Patent Document 1: PCT International Publication No. WO2013/129102

### DISCLOSURE OF INVENTION

### Problems to be Solved by the Invention

In such IoT technologies, there is a demand for reducing costs of implementing redundancy of information processing.

An object of the present invention is to provide an information processing device, a repeating device, an information processing system and method, and a program which can solve the above problem.

### Means for Solving the Problem

In order to achieve the aforementioned objects, the present invention provides an information processing device including a failure determination unit which determines whether or not a failure has occurred in the information processing device configured to perform predetermined processing on the basis of information obtained from a state information acquisition device, and a processing destination determination unit which determines, when the failure has occurred, that a sub-processing device connected to a network is a processing destination that performs the predetermined processing.

The present invention provides an information processing device including a failure determination unit which determines whether or not a failure has occurred in another information processing device configured to perform predetermined processing on the basis of information obtained from a state information acquisition device, and a processing destination determination unit which determines, when the failure has occurred, that a sub-processing device connected to a network is a processing destination that performs the predetermined processing.

The present invention also provides a repeating device including a failure determination unit which determines whether or not a failure has occurred in an information processing device configured to perform predetermined processing on the basis of information obtained from a state information acquisition device, and a processing destination determination unit which determines, when the failure has occurred, that a sub-processing device connected to a network is a processing destination that performs the predetermined processing.

The present invention also provides an information processing system including an information processing device and a sub-processing device, the information processing device including a failure determination unit which determines whether or not a failure has occurred in the information processing device configured to perform predetermined processing on the basis of information obtained from a state information acquisition device, and a processing destination determination unit which determines, when the failure has occurred, that the sub-processing device connected to a network is a processing destination that performs the predetermined processing.

The present invention also provides an information processing system including an information processing device, a repeating device, and a sub-processing device, the repeating device including a failure determination unit which determines whether or not a failure has occurred in the information processing device configured to perform predetermined processing on the basis of information obtained from a state information acquisition device, and a processing destination determination unit which determines, when the failure has occurred, that the sub-processing device connected to a network is a processing destination that performs the predetermined processing.

The present invention also provides an information processing system including a cloud server device, an information processing device, and a sub-processing device, the cloud server device including a failure determination unit which determines whether or not a failure has occurred in the information processing device configured to perform predetermined processing on the basis of information obtained from a state information acquisition device, and a processing destination determination unit which determines, when the failure has occurred, that the sub-processing device connected to a network is a processing destination that performs the predetermined processing.

The present invention also provides an information processing method including determining, by an information processing device, whether or not a failure has occurred in the information processing device configured to perform predetermined processing on the basis of information obtained from a state information acquisition device, and determining, when the failure has occurred, that a sub-processing device connected to a network is a processing destination that performs the predetermined processing.

The present invention also provides an information processing method including determining, by an information processing device, whether or not a failure has occurred in another information processing device configured to perform predetermined processing on the basis of information obtained from a state information acquisition device, and determining, when the failure has occurred, that a sub-processing device connected to a network is a processing destination that performs the predetermined processing.

The present invention also provides an information processing method for an information processing system including an information processing device and a sub-processing device, the information processing method including determining, by the information processing device, whether or not a failure has occurred in the information processing device configured to perform predetermined processing on the basis of information obtained from a state information acquisition device, and determining, when the failure has occurred, that the sub-processing device connected to a network is a processing destination that performs the predetermined processing.

The present invention also provides an information processing method for an information processing system including an information processing device, a repeating device, and a sub-processing device, the information processing method including determining, by the repeating device, whether or not a failure has occurred in the information processing device configured to perform predetermined processing on the basis of information obtained from a state information acquisition device, and determining, when the failure has occurred, that the sub-processing device connected to a network is a processing destination that performs the predetermined processing.

The present invention also provides an information processing method for an information processing system including a cloud server device, an information processing device, and a sub-processing device, the information processing method including determining, by the cloud server device, whether or not a failure has occurred in the information processing device configured to perform predetermined processing on the basis of information obtained from a state information acquisition device, and determining, when the failure has occurred, that the sub-processing device connected to a network is a processing destination that performs the predetermined processing.

The present invention also provides a program causing a computer of an information processing device to function as a failure determination means which determines whether or not a failure has occurred in the information processing device configured to perform predetermined processing on the basis of information obtained from a state information acquisition device, and a processing destination determination means which determines, when the failure has occurred, that a sub-processing device connected to a network is a processing destination that performs the predetermined processing.

The present invention also provides a program causing a computer of an information processing device to function as a failure determination means which determines whether or not a failure has occurred in another information processing device configured to perform predetermined processing on the basis of information obtained from a state information acquisition device, and a processing destination determination means which determines, when the failure has occurred, that a sub-processing device connected to a network is a processing destination that performs the predetermined processing.

### Effects of the Invention

According to the present invention, it is possible to implement redundancy suitable for IoT technologies without increasing costs.

### BRIEF DESCRIPTION OF DRAWINGS

FIG. 1 is a block diagram illustrating a configuration of an information processing system according to an embodiment of the present invention.

FIG. 2 is a functional block diagram of a cloud server device according to an embodiment of the present invention.

FIG. 3 is a first view illustrating a detailed example of a redundancy procedure.

FIG. 4 is a second view illustrating a detailed example of a redundancy procedure.

FIG. 5 is a functional block diagram of a switch according to an embodiment of the present invention.

FIG. 6 is a third view illustrating a detailed example of a redundancy procedure.

FIG. 7 is a functional block diagram of an edge terminal according to an embodiment of the present invention.

FIG. 8 is a fourth view illustrating a detailed example of a redundancy procedure.

FIG. 9 is a fifth view illustrating a detailed example of a redundancy procedure.

FIG. 10 is a view illustrating a minimal configuration of an information processing device according to the above embodiments.

### EMBODIMENTS FOR CARRYING OUT THE INVENTION

Hereinafter, an information processing device and an information processing system according to an embodiment of the present invention are described with reference to the drawings.

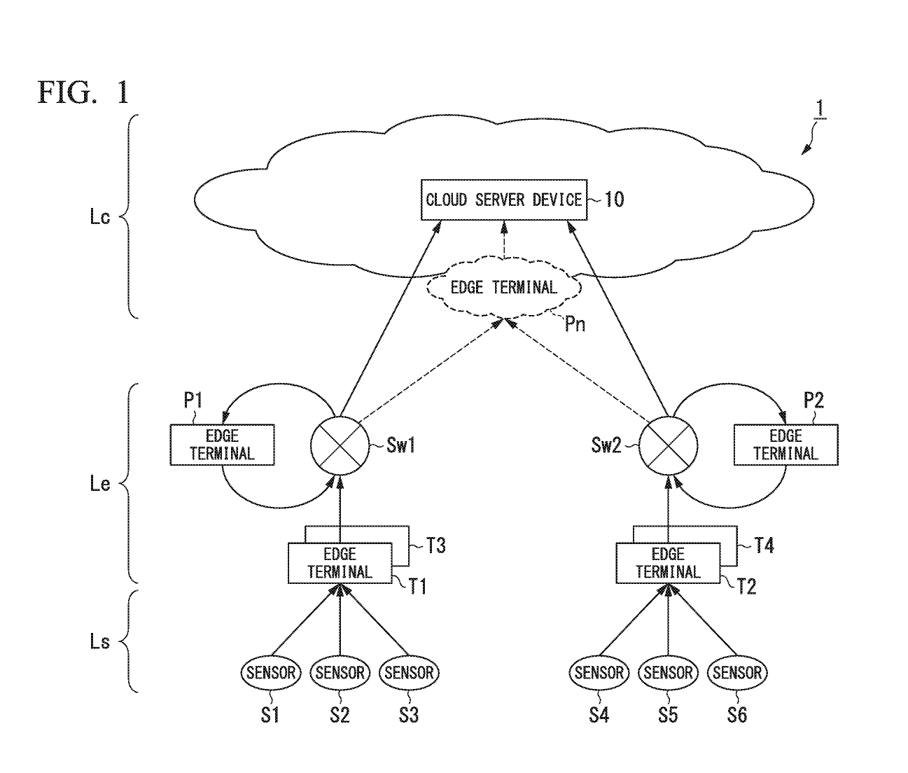

FIG. 1 is a block diagram illustrating a configuration of an information processing system according to the embodiment.

In FIG. 1, reference symbol “1” denotes an information processing system. The information processing system 1 is configured to include sensor devices S (S1 to S6 in FIG. 1), edge terminals T (T1 to T4 in FIG. 1), edge terminals P (P1 and P2 in FIG. 1), switches Sw (Sw1 and Sw2 in FIG. 1), a cloud server device 10, and an edge terminal Pn.

More specifically, two switches Sw1 and Sw2 are connected to the cloud server device 10 via a communication network.

The edge terminal T1 and the edge terminal T3 are connected to the switch Sw1 via the network. The edge terminal P1 is also connected to the switch Sw1 via the network.

The first sensor S1, the second sensor S2, and the third sensor S3 are each connected to the edge terminal T1 and the edge terminal T3 via the network.

As shown in FIG. 1, the edge terminal T2 and the edge terminal T4 are connected to the switch Sw2 via the network and the edge terminal P2 is also connected to the switch Sw2 via the network.

The fourth sensor S4, the fifth sensor S5, and the sixth sensor S6 are each connected to the edge terminal T2 and the edge terminal T4 via the network.

The sensors S1 to S6 are also collectively referred to as sensors S.

Although the three sensors S1 to S3 are described herein as being connected to the edge terminals T1 and T3, the number of sensors connected to the edge terminals T1 and T3 may also be more than or less than 3. Similarly, although the three sensors S4 to S6 are described herein as being connected to the edge terminals T2 and T4, the number of sensors connected to the edge terminals T2 and T4 may also be more than or less than 3.

In addition, in the information processing system 1 shown in FIG. 1, the edge terminal Pn is connected to the cloud server device 10 via the network.

In the information processing system 1, a layer (a network layer) in which the cloud server device and the edge terminal Pn are positioned in a network configuration of the information processing system 1 is referred to as a cloud layer Lc.

A layer (a network layer) in which the edge terminals T1 to T4, the edge terminals P1 and P2, and the switches Sw1 and Sw2 are positioned in the network configuration of the information processing system 1 is referred to as an edge layer Le.

A layer (a network layer) in which the sensors S1 to S6 are positioned in the network configuration of the information processing system 1 is referred to as a sensor layer Ls.

The edge terminals T1 and T3 (protocol conversion devices) are information processing devices which acquire information from sensors and these two units provide a redundant configuration.

The edge terminals T2 and T4 (protocol conversion devices) are also information processing devices which acquire information from sensors and these two units provide a redundant configuration.

When information indicating to let the information acquired from sensors processed on the cloud layer Lc has been stored, each of the edge terminals T1 to T4 transmits the acquired information to an information processing device (the cloud server device 10 or the edge terminal Pn) positioned in the cloud layer Lc.

When the edge terminals T1 to T4 transmit information acquired from sensors to the cloud server device 10 or the edge terminal Pn, each of the edge terminals T1 to T4 transmits information received from the sensors S to the cloud server device 10 or the edge terminal Pn at a higher layer, by converting, for example, a communication protocol for communication of data (received from the sensors S) with the sensors S (specifically, converts a protocol for communication between the sensors S and the edge terminals T1 to T4 into TCP/IP).

On the other hand, when information indicating that the edge layer Le is allowed to process information acquired from sensors S has been stored, each of the edge terminals T1 to T4 transmits the acquired information to an information processing device (the edge terminal P1 or the edge terminal P2) which is positioned in the edge layer Le and connected to the network.

The edge terminals P1 and P2 are information processing devices (application devices) provided to reduce information processing capabilities required for the cloud server device 10.

Through processing by the edge terminals P1 and P2, it is possible to quickly complete information processing based on information acquired from the sensors S1 and S6 without processing by the cloud server device 10 and to output results of the processing to an output device connected to the sensor layer Ls or the edge layer Le (which may be, for example, the edge terminals P1 and P2 or the edge terminals T1 to T4).

The edge terminals P1 and P2 may also output results of the information processing to an output device connected to the cloud layer Lc (which may be the cloud server device 10 or the edge terminal Pn).

The switch Sw1 is an information processing device which determines whether information output from the edge terminals T1 and T3 connected to the switch Sw1 is to be output to the edge terminal P1 or is to be output to the cloud server device 10 or the edge terminal Pn and then performs transmission accordingly.

The switch Sw2 is an information processing device which determines whether information output from the edge terminals T2 and T4 connected to the switch Sw2 is to be output to the edge terminal P2 or is to be output to the cloud server device 10 or the edge terminal Pn and then performs transmission accordingly.

Although the edge terminals T1, T3, and P1 are shown as separate devices in FIG. 1, the edge terminals T1, T3, and P1 may be three functions virtually constructed in a single server device.

Alternatively, the edge terminals T1 and T3 may be two functions virtually constructed in a single server device while the edge terminal P1 is an information processing device separately provided as independent hardware.

In the case where a plurality of functions are virtually provided in a single server device, the functions are connected via a virtual network.

A function of the switch Sw1 may further be virtually provided in a server device in which two functions of the edge terminals T1 and T3 are virtually provided or in a server device in which three functions of the edge terminals T1, T3, and P1 are virtually provided.

Similarly, although the edge terminals T2, T4, and P2 are shown as separate devices in FIG. 1, the edge terminals T2, T4, and P2 may be three functions virtually constructed in a single server device.

Alternatively, the edge terminals T2 and T4 may be two functions virtually constructed in a single server device while the edge terminal P2 is an information processing device separately provided as independent hardware.

In the case where a plurality of functions are virtually provided in a single server device, the functions are connected via a virtual network as described above.

A function of the switch Sw2 may further be virtually provided in a server device in which two functions of the edge terminals T2 and T4 are virtually provided or in a server device in which three functions of the edge terminals T2, T4, and P2 are virtually provided.

The cloud server device 10 receives data sensed by the sensors S1 to S6, which has been transmitted from the edge terminals P1 and P2 or the edge terminals T1 to T4 via the switches Sw1 and Sw2, and performs predetermined information processing.

For example, when the sensors S1 to S6 are cameras, captured image data is acquired and the cloud server device 10 performs specific processing on an image of a person. When the sensors S1 to S6 provide product information, the cloud server device 10 performs inventory-related processing. When the sensors S1 to S6 provide temperature information of a specific environment, the cloud server device 10 performs temperature prediction processing of the specific environment.

The cloud server device 10 performs given information processing on the basis of data acquired by the sensors S1 to S6. The edge terminals P1 and P2 are provided to assume part of the information processing in order to reduce the information processing of the cloud server device 10.

The edge terminal Pn is an information processing device (a sub-processing device that performs redundant processing) which operates instead of the edge terminals P1 and P2 when the edge terminals P1 and P2 are not operable due to malfunction or the like, and can perform the same information processing as the information processing assumed by the edge terminals P1 and P2. That is, the edge terminal Pn corresponds to a sub-processing device that is commonly used as a redundant configuration by a plurality of information processing devices. The edge terminal Pn may also be an information processing device virtually provided in the cloud server device 10.

In the information processing system 1 according to the present embodiment, the edge terminal Pn, which is a redundant configuration of the edge terminals P1 and P2, is provided in the cloud layer Lc and is commonly used by different groups of information processing devices in the edge layer. In the present embodiment, the word “different groups of information processing devices” refers to a group of information processing devices including the edge terminals P1, T1, and T3, the switch Sw1, and the sensors S1, S2, and S3 and a group of information processing devices including the edge terminals P2, T2, and T4, the switch Sw2, and the sensors S4, S5, and S6.

Providing such an edge terminal Pn in the cloud layer Lc simplifies a redundant configuration of the edge terminals in the edge layer Le and makes it possible to implement redundancy suitable for IoT technologies without increasing costs.

### (Description of First Redundancy Procedure)

The following is a description of a detailed example of a first redundancy procedure.

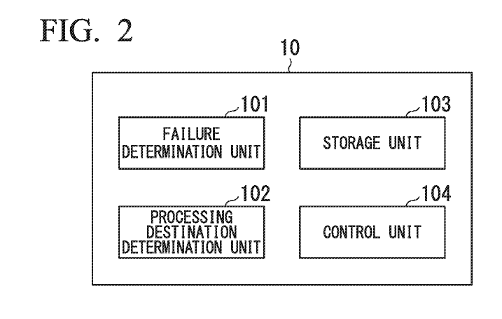

FIG. 2 is a functional block diagram of the cloud server device 10.

The edge terminal P1 described above performs predetermined application processing on the basis of information acquired from any of the sensors S1 to S3 via the switch Sw1. The edge terminal P2 described above performs predetermined application processing on the basis of information acquired from any of the sensors S4 to S6 via the switch Sw2.

The cloud server device 10 includes a failure determination unit 101 that determines whether or not a failure has occurred in the edge terminals P1 and P2.

The cloud server device 10 also includes a processing destination determination unit 102 which determines that the edge terminal Pn is a processing destination that performs predetermined processing instead of the edge terminals P1 and P2, which are configured to perform the predetermined processing, when a failure has occurred in the edge terminals P1 and P2.

The cloud server device 10 also includes a storage unit 103 and a control unit 104.

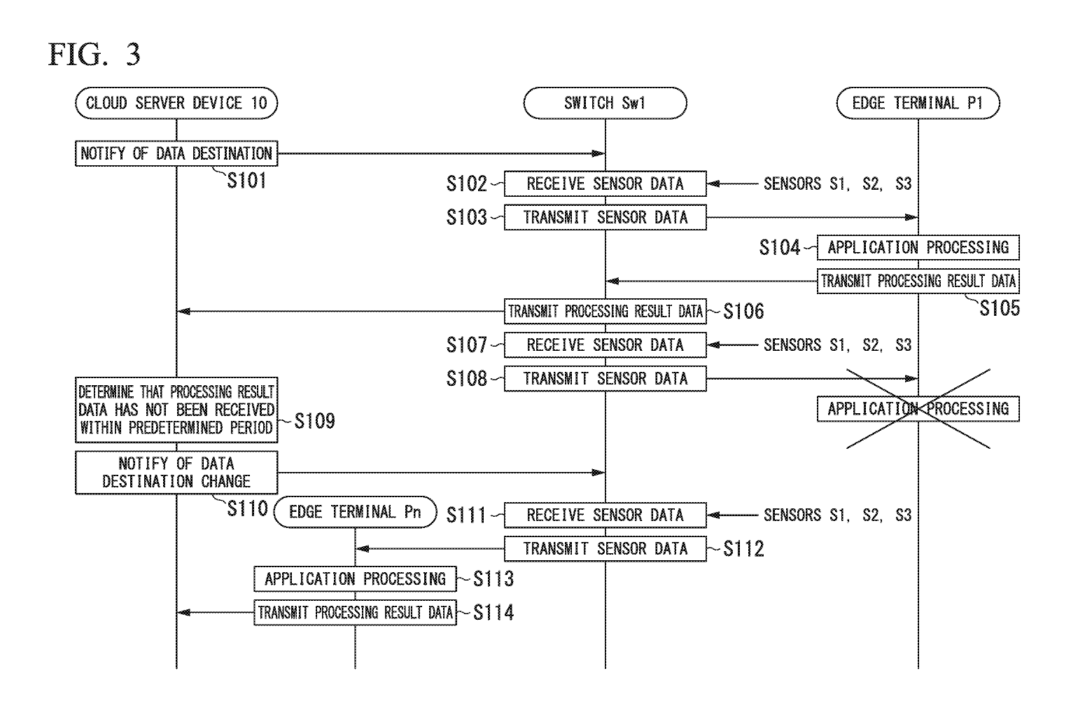

FIG. 3 is a first view illustrating a process flow of the redundancy procedure. First, the cloud server device 10 notifies the switch Sw1 of a data destination to which data is to be transmitted (step S101). Here, it is assumed that the data destination is the edge terminal P1 at the initial stage. Accordingly, the switch Sw1 stores information of the edge terminal P1 in a storage unit of the switch Sw1. In this situation, it is assumed that the edge terminal T1 is in an active state (i.e., in a processing state (in which it performs processing)) and the edge terminal T3 is in a standby state (i.e., in a monitoring state (in which it performs monitoring)).

A redundancy processing unit provided by the edge terminal T1 and the edge terminal T3 operates such that, when an abnormality has occurred in a terminal in an active state, through a hot standby process or the like, a terminal in a standby state is automatically activated and transmits data received from the sensors S1 to S3 to the switch Sw1 at a higher layer. The switch Sw1 then receives the data of the sensors S1 to S3 (step S102).

The switch Sw1 transmits the data of the sensors S1 to S3 received from the edge terminal T1 or the edge terminal T3 to the edge terminal P1 since the switch Sw1 has been notified that the data destination is the edge terminal P1 in step S101 (step S103). Here, only data which has predetermined information stored in a header thereof may be transmitted to the edge terminal P1 (while data which does not have predetermined information stored in a header thereof is transmitted to the cloud server device 10). Accordingly, the edge terminal P1 receives the data and performs specific application processing (step S104).

The edge terminal P1 transmits processing result data of the application processing to the switch Sw1 (step S105) and the switch Sw1 transmits the processing result data to the cloud server device 10 (step S106).

On the other hand, the failure determination unit 101 of the cloud server device 10 determines whether or not the processing result data has been received from the edge terminal P1 via the switch Sw1 within a predetermined period of time. When the failure determination unit 101 of the cloud server device 10 has determined that the processing result data has been received from the edge terminal P1 within the predetermined period of time, the control unit 104 of the cloud server device 10 performs some processing using the processing result data.

Similar to the above description, it is assumed that the switch Sw1 has received the data of the sensors S1 to S3 (step S107). The switch Sw1 transmits the data of the sensors S1 to S3 received from the edge terminal T1 or the edge terminal T3 to the edge terminal P1 since the switch Sw1 has been notified that the data destination is the edge terminal P1 in step S101 (step S108).

However, when an abnormality has occurred in the edge terminal P1 or in communication with the edge terminal P1, application processing by the edge terminal P1 is not completed or the processing result data is not transmitted to the cloud server device 10 via the switch Sw1. In this case, the failure determination unit 101 of the cloud server device 10 determines that the processing result data has not been received from the edge terminal P1 in the predetermined period (step S109).

In response to this, the processing destination determination unit 102 of the cloud server device 10 determines that the processing destination that performs application processing is to be changed to the edge terminal Pn. The processing destination determination unit 102 then transmits a change notification of a data destination to the switch Sw1 (step S110). Information of the edge terminal Pn is stored as the data destination in this change notification.

The switch Sw1 reads the information of the edge terminal Pn as the data destination from the received change notification and stores the read information in the storage unit of the switch Sw1.

Similar to the above description, it is assumed that the switch Sw1 has received the data of the sensors S1 to S3 (step S111). The switch Sw1 transmits the data of the sensors S1 to S3 received from the edge terminal T1 or the edge terminal T3 to the edge terminal Pn since the switch Sw1 has been notified that the data destination is the edge terminal Pn in step S110 (step S112).

Accordingly, the edge terminal Pn receives the data and performs predetermined application processing instead of the edge terminal P1 (step S113). The edge terminal Pn transmits processing result data of the application processing to the cloud server device 10 (step S114).

The control unit 104 of the cloud server device 10 performs predetermined processing using the processing result data.

The same processes as described above are also performed on a group including the cloud server device 10, the switch Sw2, the edge terminal P2, the edge terminals T2 and T4, and the sensors S4 to S6.

According to the above processes, by using a simplified configuration in which the edge terminal Pn, which is a redundant configuration of the edge terminal P1 provided in the edge layer Le, is shared by a plurality of groups, redundancy suitable for IoT technologies can be implemented without increasing costs.

### (Description of Second Redundancy Procedure)

The following is a description of a detailed example of a second redundancy procedure.

A configuration of the cloud server device 10 in the second redundancy procedure is similar to that shown in FIG. 2.

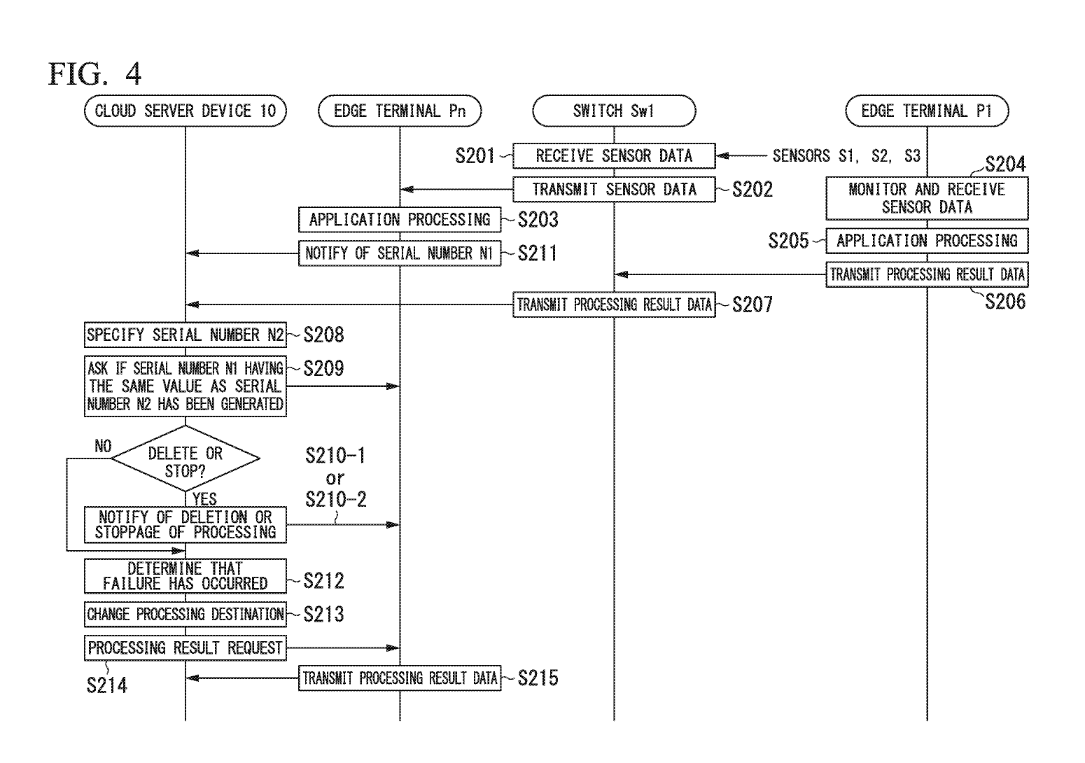

FIG. 4 is a second view illustrating a process flow of the redundancy procedure.

First, the switch Sw1 receives data of the sensors S1 to S3 from the edge terminals T1 and T3 (step S201). The switch Sw1 then transmits the received data of the sensors S1 to S3 to the preset edge terminal Pn (step S202).

The edge terminal Pn then performs the same application processing as that of the edge terminal P1 using the received data of the sensors S1 to S3 (step S203). Here, the edge terminal Pn also performs application processing using data of the sensors S4 to S6 received from a switch (i.e., the switch Sw2) of another group (i.e., a group of the information processing system including the sensors S4 to S6, the edge terminals T2 and T4, the edge terminal P2, and the switch Sw2).

The edge terminal Pn stores a first serial number N1, which counts up in response to termination of each processing, in the processing result data of the application processing.

In this situation, the edge terminal P1 monitors and receives the data of the sensors S1 to S3 which the switch Sw1 has transmitted to the edge terminal Pn (step S204). For this monitoring, the edge terminal P1 needs to be communicably connected to a network position at which it is possible to monitor communication signals transmitted to the edge terminal Pn by the switch Sw1.

The edge terminal P1 then performs predetermined application processing, which is requested to the edge terminal P1, on the basis of information that has been monitored and received (step S205). The edge terminal P1 transmits processing result data of the application processing to the switch Sw1 (step S206).

In response to this, the switch Sw1 transmits the processing result data to the cloud server device 10 (step S207). Here, it is assumed that a second serial number N2, which counts up in response to termination of each processing, has been stored in the processing result data.

It is also assumed that processing of the edge terminal Pn has been synchronized with that of the edge terminal P1 such that the first serial number N1 and the second serial number N2, which are given to the application processing using the same data received from the sensors S1 to S3, are the same numbers. Specific examples of this synchronization process include those of any known synchronization method.

The control unit 104 of the cloud server device 10 specifies the second serial number N2 from the received processing result data (step S208). The control unit 104 of the cloud server device 10 asks the edge terminal Pn if the edge terminal Pn has generated a value of the first serial number N1 equal to the specified second serial number N2 among those of the first serial number N1 generated through application processing performed on the basis of data received from the switch Sw1 (step S209).

In a state in which no failure has occurred in the edge terminal P1, the processing destination determination unit 102 stores that the edge terminal P1 is the processing destination that performs the application processing.

When a notification that a serial number N1 having the same value as the specified second serial number N2 has been generated has been received from the edge terminal Pn, the control unit 104 of the cloud server device 10 notifies the edge terminal Pn that the processing result data in which the first serial number N1 is stored is to be deleted (step S210-1).

Alternatively, when the edge terminal Pn can determine that the first serial number N1 is that of data which is currently being processed by the edge terminal Pn, the control unit 104 may notify the edge terminal Pn that processing of the edge terminal Pn is to be stopped (step S210-2).

The cloud server device 10 receives a notification of the generated first serial number N1 from the edge terminal Pn (step S211).

The failure determination unit 101 of the cloud server device 10 determines whether or not a failure has occurred in the edge terminal P1 by comparing the first serial number N1 of which the edge terminal Pn has notified with the second serial number N2 acquired from the processing result data which has been received from the edge terminal P1 via the switch Sw1.

When the first serial number N1 has a value greater than that of the second serial number N2 and the difference between the values is greater than or equal to a predetermined value, the failure determination unit 101 determines that a failure has occurred in the edge terminal P1 (step S212).

In response to this, the processing destination determination unit 102 of the cloud server device 10 rewrites and changes information of the processing destination stored in the storage unit 103 from the edge terminal P1 to the edge terminal Pn (step S213).

The control unit 104 of the cloud server device 10 then determines a second serial number N2 which is included in the last received of those processing result data items that have been received from the edge terminal P1 via the switch Sw1 and transmits a request for a processing result in which the second serial number N2 is stored to the edge terminal Pn (step S214).

In response to this, the edge terminal Pn adds “1” to the value of the second serial number N2 included in the received processing result request. Then, the edge terminal Pn also transmits a processing result data items of processing that has been performed thereafter, in order from the processing result data, in which a serial number N1 equal to the added value of the second serial number N2 is stored, to the cloud server device 10 (step S215).

The control unit 104 of the cloud server device 10 performs predetermined processing using the processing result data received from the edge terminal Pn. That is, the cloud server device 10 uses the processing result data of application processing that the edge terminal Pn has performed as redundant processing.

The cloud server device 10, the edge terminal P1, and the switch Sw2 also perform the same processes as described above for the group including the edge terminals T2, T4, and P2, the switch Sw2, and the sensors S4 to S6.

In the processes described above, the processing destination determination unit 102 of the cloud server device 10 determines whether or not a failure has occurred in the edge terminal P1 on the basis of a magnitude relationship between the second serial number N2 included in the processing result data from the edge terminal P1 and the first serial number N1 of which the edge terminal Pn has notified and then transmits a processing result request to the edge terminal Pn when a failure has occurred.

However, the processing destination determination unit 102 of the cloud server device 10 may also previously receive processing result data from each of the edge terminal P1 and the edge terminal Pn and determine which is to be used by the cloud server device 10. This determination can be considered as determining the processing destination.

For example, the processing destination determination unit 102 of the cloud server device 10 reads a serial number (the first serial number N1 or the second serial number N2) from processing result data received from the edge terminal P1 or the edge terminal Pn and determines that the processing result data is to be used when the read serial number has a value acquired for the first time. On the other hand, when the serial number read from the received processing result data has a value that has already been acquired, the processing destination determination unit 102 determines that the processing result data in which the serial number is stored is not to be used.

This allows the cloud server device 10 to use a processing result data item which the cloud server device 10 can first receive from among the same processing result data items transmitted from the edge terminal P1 or the edge terminal Pn (i.e., this corresponds to determining that an edge terminal which has generated the processing result data item is the processing destination).

According to the above processes, by using a simplified configuration in which the edge terminal Pn, which is a redundant configuration of the edge terminal P1 provided in the edge layer Le, is shared by a plurality of groups, redundancy suitable for IoT technologies can be implemented without increasing costs.

Another advantage is that it is unnecessary to reacquire data of the sensors S1 to S6 required for the edge terminal Pn to perform application processing when a failure has occurred in the edge terminals P1 and P2 since the edge terminal Pn always performs application processing. It is also unnecessary to explicitly specify and set the processing destination for the switches Sw1 and Sw2.

### (Description of Third Redundancy Procedure)

The following is a description of a detailed example of a third redundancy procedure.

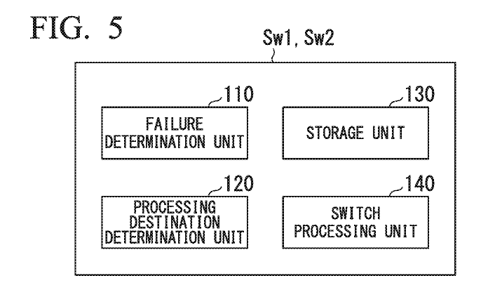

FIG. 5 is a functional block diagram of a switch Sw1 in this example. The switch Sw1 includes a failure determination unit 110 that determines whether or not a failure has occurred in the edge terminal P1 that performs predetermined processing on the basis of information obtained from the sensors S1 to S3.

The switch Sw1 also includes a processing destination determination unit 120 which determines that the edge terminal Pn connected to the cloud layer Lc is a processing destination that performs predetermined application processing when a failure has occurred in the edge terminal P1.

The switch Sw1 also includes a storage unit 130 and a switch processing unit 140 that performs a switching process on received information and transmits the received information to another device.

A functional configuration of the switch Sw2 is similar to that described above.

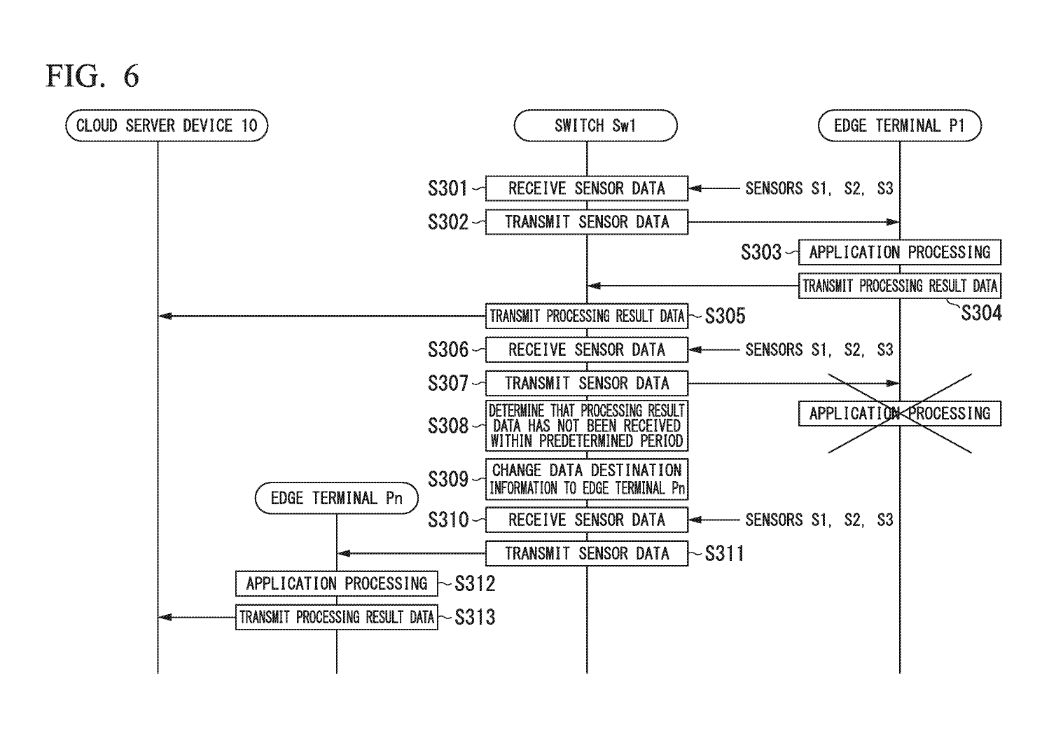

FIG. 6 is a third view illustrating a process flow of the redundancy procedure.

First, the switch Sw1 has recorded that the edge terminal P1 is a data destination at the initial stage in the storage unit 130. In this state, it is assumed that the edge terminal T1 is in an active state (i.e., in a processing state) and the edge terminal T3 is in a standby state (i.e., in a monitoring state).

A redundancy processing unit provided by the edge terminal T1 and the edge terminal T3 operates such that, when an abnormality has occurred in a terminal in an active state, through a hot standby process or the like, a terminal in a standby state is automatically activated and transmits data received from the sensors S1 to S3 to the switch Sw1 at a higher layer. The switch Sw1 then receives the data of the sensors S1 to S3 (step S301).

The switch Sw1 transmits the data of the sensors S1 to S3 received from the edge terminal T1 or the edge terminal T3 to the edge terminal P1 since the switch Sw1 has recorded the edge terminal P1 in the storage unit 130 as the data destination at the initial stage (step S302).

Here, only data which has predetermined information stored in a header thereof may be transmitted to the edge terminal P1 (while data which does not have predetermined information stored in a header thereof is transmitted to the cloud server device 10). Accordingly, the edge terminal P1 receives the data and performs specific application processing (step S303).

The edge terminal P1 transmits processing result data of the application processing to the switch Sw1 (step S304) and the switch Sw1 transmits the processing result data to the cloud server device 10 (step S305).

Similar to the above description, it is assumed that the switch Sw1 has received the data of the sensors S1 to S3 (step S306). The data of the sensors S1 to S3 is repeatedly received. The switch Sw1 transmits the data of the sensors S1 to S3 to the edge terminal P1 since the switch Sw1 has stored the edge terminal P1 as a data destination (step S307).

However, when an abnormality has occurred in the edge terminal P1 or in a path of communication with the edge terminal P1, application processing by the edge terminal P1 is not completed or the processing result data is not transmitted to the cloud server device 10 via the switch Sw1. In this case, the failure determination unit 101 of the switch Sw1 determines that the processing result data has not been received from the edge terminal P1 in the predetermined period (step S308).

In response to this, the processing destination determination unit 120 of the switch Sw1 determines that the processing destination that performs application processing is to be changed to the edge terminal Pn. The processing destination determination unit 120 then changes information of the data destination stored in the switch Sw1 from the edge terminal P1 to the edge terminal Pn (step S309).

Similar to the above description, it is assumed that the switch Sw1 has received the data of the sensors S1 to S3 (step S310). The switch Sw1 transmits the received data of the sensors S1 to S3 to the edge terminal Pn since the switch Sw1 has stored the edge terminal Pn as the data destination (step S311).

Accordingly, the edge terminal Pn receives the data and performs predetermined application processing instead of the edge terminal P1 (step S312). The edge terminal Pn transmits processing result data of the application processing to the cloud server device 10 (step S313).

The control unit 104 of the cloud server device 10 performs predetermined processing using the processing result data.

The same processes as described above are also performed on a group including the cloud server device 10, the switch Sw2, the edge terminal P2, the edge terminals T2 and T4, and the sensors S4 to S6.

According to the above processes, by using a simplified configuration in which the edge terminal Pn, which is a redundant configuration of the edge terminal P1 provided in the edge layer Le, is shared by a plurality of groups, redundancy suitable for IoT technologies can be implemented without increasing costs.

### (Description of Fourth Redundancy Procedure)

The following is a description of a detailed example of a fourth redundancy procedure.

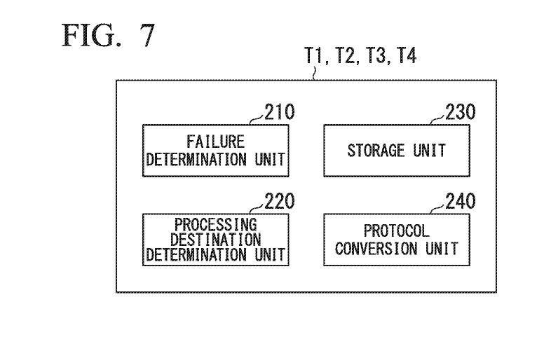

FIG. 7 is a functional block diagram of an edge terminal T1 in this example. The edge terminal T1 includes a failure determination unit 210 that determines whether or not a failure has occurred in the edge terminal P1 that performs predetermined processing on the basis of information obtained from the sensors S1 to S3.

The edge terminal T1 also includes a processing destination determination unit 220 which determines that the edge terminal Pn connected to the cloud layer Lc is a processing destination that performs predetermined application processing when a failure has occurred in the edge terminal P1.

The edge terminal T1 also includes a storage unit 230 and a protocol conversion unit 240 that transmits information received from the sensors to the cloud server device 10 or the edge terminal Pn via the switch Sw1 by converting a communication protocol for communication of data received from the sensors with the sensors.

The configurations of the edge terminals T2, T3, and T4 are similar to that described above.

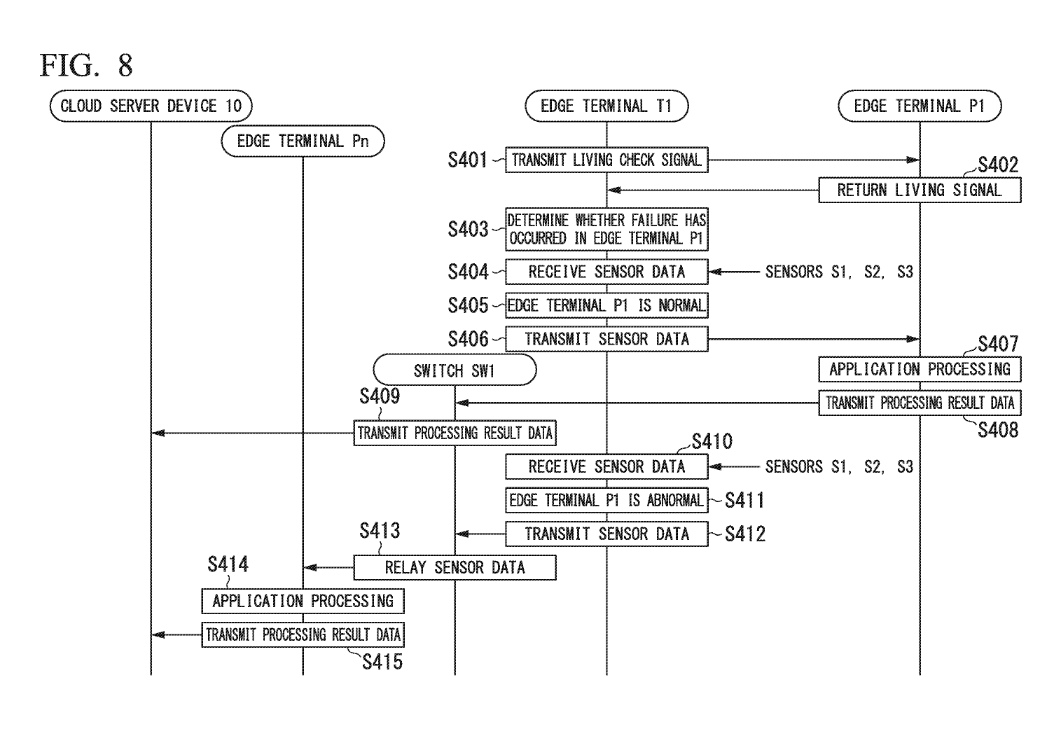

FIG. 8 is a fourth view illustrating a process flow of the redundancy procedure.

Here, it is assumed that, among the edge terminals T1 and T3, the edge terminal T1 is operating as an active edge terminal. The edge terminal T1 has recorded that the edge terminal P1 is a data destination at the initial stage in the storage unit 230.

In this state, the edge terminal T1 transmits a living check signal to the edge terminal P1 which has been recorded as the data destination at the initial stage (step S401). When the edge terminal P1 is normal, the edge terminal P1 returns a living signal to the edge terminal T1 upon receiving the living check signal (step S402).

The edge terminal T1 determines whether or not a failure has occurred in the edge terminal P1 (step S403). The edge terminal T1 determines that a failure has occurred in the edge terminal P1 when a living signal responding to the living check signal cannot be received within a predetermined period of time or when a living signal cannot be received even though a living check signal has been transmitted a plurality of times.

The edge terminal T1 receives data from the sensors S1 to S3 (step S404). Here, when the edge terminal T1 has determined that the edge terminal P1 is normal (step S405), the edge terminal T1 performs a process of converting a protocol for communication of data with the sensors S1 to S3 and transmits the sensor data of the sensors S1 to S3 to the edge terminal P1 (step S406).

Here, only data which has predetermined information stored in a header thereof may be transmitted to the edge terminal P1 (while data which does not have predetermined information stored in a header thereof is transmitted to the cloud server device 10). Accordingly, the edge terminal P1 receives the data and performs specific application processing (step S407).

The edge terminal P1 transmits processing result data of the application processing to the switch Sw1 (step S408) and the switch Sw1 transmits the processing result data to the cloud server device 10 (step S409).

At another time, the edge terminal T1 receives data from the sensors S1 to S3 (step S410).

When the edge terminal T1 has determined that the edge terminal P1 is abnormal (step S411), the edge terminal T1 performs a process of converting a protocol for communication of data with the sensors S1 to S3 and transmits the sensor data of the sensors S1 to S3 to the switch Sw1 (step S412), such that the switch Sw1 relays the sensor data to the edge terminal Pn (step S413).

The edge terminal Pn then receives the data and performs specific application processing (step S414). The edge terminal Pn transmits processing result data of the application processing to the cloud server device 10 (step S415).

According to the above processes, by using a simplified configuration in which the edge terminal Pn, which is a redundant configuration of the edge terminal P1 provided in the edge layer Le, is shared by a plurality of groups, redundancy suitable for IoT technologies can be implemented without increasing costs.

### (Description of Fifth Redundancy Procedure)

The following is a description of a detailed example of a fifth redundancy procedure.

A configuration of the cloud server device 10 in the fifth redundancy procedure is similar to that shown in FIG. 5.

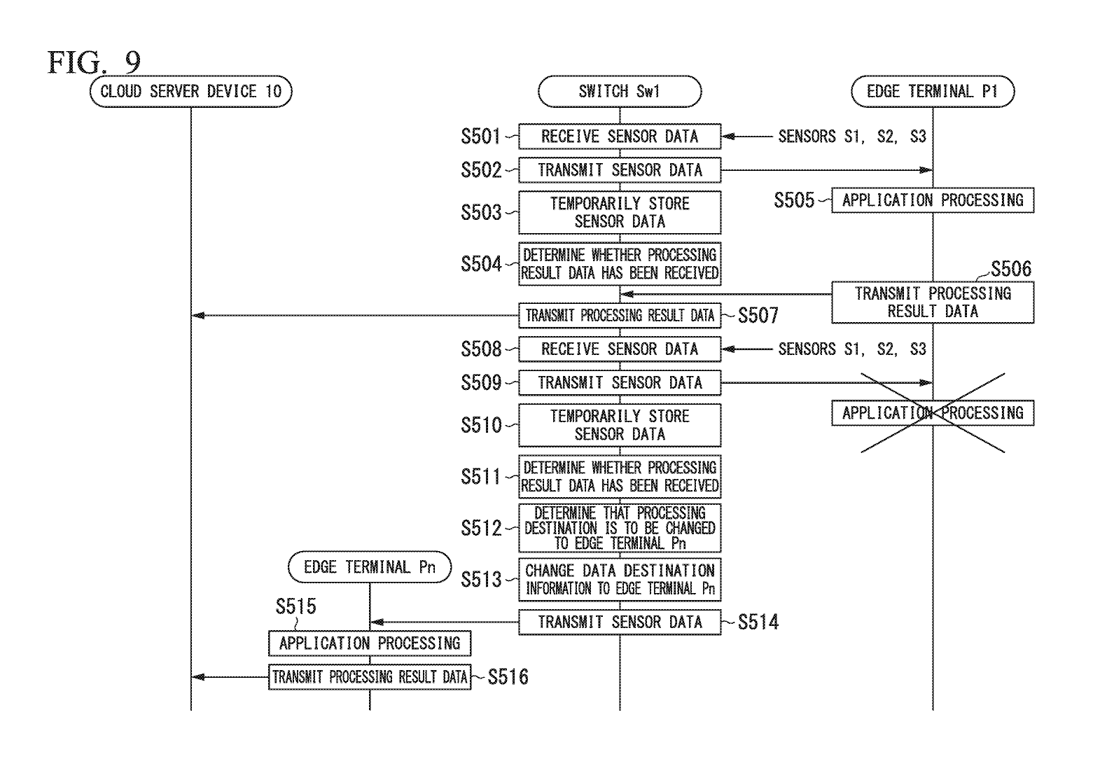

FIG. 9 is a fifth view illustrating a process flow of the redundancy procedure.

First, the switch Sw1 receives data of the sensors S1 to S3 from the edge terminal T1 (step S501). The switch Sw1 then transmits the received data of the sensors S1 to S3 to the edge terminal P1 (step S502).

Here, only data which has predetermined information stored in a header thereof may be transmitted to the edge terminal P1 (while data which does not have predetermined information stored in a header thereof is transmitted to the cloud server device 10).

The switch Sw1 also temporarily stores the transmitted data of each of the sensors in the storage unit 130 of the switch Sw1 (step S503). After the sensor data is stored, the failure determination unit 110 of the switch Sw1 determines whether or not processing result data has been received from the edge terminal P1 within a predetermined period of time (step S504).

The edge terminal P1 performs application processing using the received data of the sensors S1 to S3 (step S505). The edge terminal P1 also transmits processing result data of the application processing to the switch Sw1 (step S506).

When the failure determination unit 110 of the switch Sw1 has determined that processing result data has been received from the edge terminal P1 within the predetermined period of time, the switch processing unit 140 transmits the processing result data to the cloud server device 10 (step S507).

Similarly, at a subsequent time, the switch Sw1 receives data of the sensors S1 to S3 from the edge terminal T1 (step S508). The switch Sw1 then transmits the received data of the sensors S1 to S3 to the edge terminal P1 (step S509).

The switch Sw1 also temporarily stores the transmitted data of each of the sensors in the storage unit 130 of the switch Sw1 (step S510). After the sensor data is stored, the failure determination unit 110 of the switch Sw1 determines whether or not processing result data has been received from the edge terminal P1 within a predetermined period of time (step S511).

Here, when processing result data cannot be received from the edge terminal P1 even though the predetermined period of time has elapsed, the processing destination determination unit 120 of the switch Sw1 determines that the processing destination that performs application processing is to be changed to the edge terminal Pn (step S512).

The processing destination determination unit 102 then changes information of the data destination stored in the switch Sw1 from the edge terminal P1 to the edge terminal Pn (step S513). Then, since the data destination has been changed to the edge terminal Pn, the switch Sw1 transmits the data of the sensors S1 to S3 temporarily stored in the storage unit to the edge terminal Pn (step S514).

Accordingly, the edge terminal Pn receives the data and performs predetermined application processing instead of the edge terminal P1 (step S515). The edge terminal Pn transmits processing result data of the application processing to the cloud server device 10 (step S516).

The control unit 104 of the cloud server device 10 performs predetermined processing using the processing result data.

The same processes as described above are also performed on a group including the cloud server device 10, the switch Sw2, the edge terminal P2, the edge terminals T2 and T4, and the sensors S4 to S6.

According to the above processes, by using a simplified configuration in which the edge terminal Pn, which is a redundant configuration of the edge terminal P1 provided in the edge layer Le, is shared by a plurality of groups, redundancy suitable for IoT technologies can be implemented without increasing costs.

When a function of the edge terminal Pn is virtually provided in the cloud server device 10 in the first and second redundancy procedures described above, the cloud server device 10 has the following elements:

(i) a failure determination unit that determines whether or not a failure has occurred in the edge terminal P1 (which is an information processing device) that performs predetermined application processing on the basis of information obtained from the sensor S (which is state information acquisition devices); and

(ii) a processing destination determination unit that determines, when a failure has occurred in the edge terminal P1, that the cloud server device (as the edge terminal Pn) which is positioned in the cloud layer of the cloud network and is connected to the cloud network is a processing destination that performs the predetermined application processing.

In the third, fourth, and fifth redundancy procedures described above, the switch Sw1 or the edge terminal T1 includes a failure determination unit that determines whether or not a failure has occurred in the edge terminal P1 (which is an information processing device) that performs predetermined application processing on the basis of information obtained from the sensor S (which is state information acquisition devices).

In the third, fourth, and fifth redundancy procedures, the switch Sw1 or the edge terminal T1 also includes a processing destination determination unit that determines, when a failure has occurred in the edge terminal P1, that the edge terminal Pn (a sub-processing device) which is positioned in the cloud layer of the cloud network and is connected to the cloud network is a processing destination that performs the predetermined application processing.

When the switch Sw1 or the edge terminal T1 and the edge terminal P1 are virtually provided in the same information processing device in the third, fourth, and fifth redundancy procedures described above, the information processing device has the following elements:

(i) a failure determination unit that determines whether or not a failure has occurred in the information processing device that performs predetermined application processing on the basis of information obtained from the sensor S (which is state information acquisition devices); and

(ii) a processing destination determination unit that determines, when a failure has occurred in the information processing device, that the edge terminal Pn (a sub-processing device) which is positioned in the cloud layer of the cloud network and is connected to the cloud network is a processing destination that performs the predetermined application processing.

As an additional process in the above embodiments, for example, the edge terminals T1 to T4 may analyze sensor data and convert the sensor data into data which can be used by the system. In this case, for example, without the edge terminals T2 and T3 being provided, the edge terminal T1 and the edge terminal Pn may implement redundancy for the analyzing process such that any of the edge terminal T1 and the edge terminal Pn performs the process.

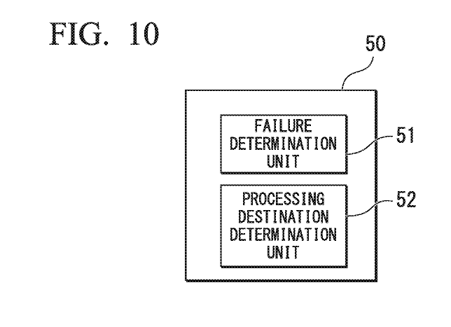

FIG. 10 is a view illustrating a minimal configuration of an information processing device according to the above embodiments.

As shown in FIG. 10, in the first to fifth redundancy procedures, an information processing device 50 such as the cloud server 10 or the switch Sw1 includes at least a failure determination unit 51 and a processing destination determination unit 52.

The failure determination unit 51 of the information processing device 50 determines whether or not a failure has occurred in another information processing device (such as the edge terminal P1) which performs predetermined processing on the basis of information obtained from state information acquisition devices (such as the sensor S).

When a failure has occurred in the other information processing device, the processing destination determination unit 52 of the information processing device 50 determines that a sub-processing device (i.e., the edge terminal Pn) which is connected to the system including the information processing device via the network is a processing destination that performs predetermined processing.

When the edge terminals T, the switch Sw1, and the edge terminal P1 are provided in the same information processing device 50 (such as the server) in the third, fourth, and fifth redundancy procedures described above, the information processing device 50 may include at least the failure determination unit 51 and the processing destination determination unit 52.

In this case, the failure determination unit 51 of the information processing device 50 determines whether or not a failure has occurred in the information processing device 50 which performs predetermined processing on the basis of information obtained from state information acquisition devices (for example, the sensor S). When a failure has occurred in the information processing device 50, the processing destination determination unit 52 of the information processing device 50 determines that a sub-processing unit (a redundant processing device) which is connected to the network is a processing destination that performs predetermined processing.

Each of the information processing devices described above, i.e., the edge terminals T1, T2, T3, and T4, the edge terminals P1 and P2, the switches Sw1 and Sw2, the edge terminal Pn, and the cloud server device 10, has a computer system therein. A program causing each of these information processing devices to perform corresponding processes described above is stored in a computer readable recording medium of the information processing device and the processes are performed by a computer of the information processing device reading and executing the program.

Here, the term “computer readable recording medium” refers to a magnetic disk, a magneto-optical disk, a CD-ROM, a DVD-ROM, a semiconductor memory, or the like. The computer program may also be transmitted to a computer via communication lines, and the computer may execute the program upon receiving the program.

The above program may be one for realizing a part of the functionality of each of the processing units described above.

The above program may also be a so-called differential file (a differential program) which is able to realize the functionality described above in combination with a program which has already been recorded in a computer system.

Although embodiments of the present invention have been described in detail with reference to the drawings, specific configurations thereof are not limited to those described above and various design changes or the like are possible without departing from the nature of the present invention.

Priority is claimed on Japanese Patent Application No. 2015-059360, filed Mar. 23, 2015, the content of which is incorporated herein by reference.

### INDUSTRIAL APPLICABILITY

According to the present invention, it is possible to implement redundancy suitable for IoT technologies without increasing costs.

### REFERENCE SYMBOLS

1 Information processing system
10 Cloud server device
S1-S6 Sensors
T1-T3 Edge terminals (protocol conversion devices which are first repeating
devices)
P1, P2 Edge terminals (application processing devices)
Pn Edge terminal (sub-processing device)
Sw1, Sw2 Switches (second repeating devices)

1.-5. (canceled)

6. An information processing system comprising:
a sub-processing device; and
an information processing device including
a failure determination unit configured to determine whether or not a failure has occurred in the information processing device configured to perform predetermined processing on the basis of information obtained from a state information acquisition device, and
a processing destination determination unit configured to determine, when the failure has occurred, that the sub-processing device connected to a network is a processing destination that performs the predetermined processing.

7. An information processing system comprising:
an information processing device;
a sub-processing device; and
a repeating device including
a failure determination unit configured to determine whether or not a failure has occurred in the information processing device configured to perform predetermined processing on the basis of information obtained from a state information acquisition device, and
a processing destination determination unit configured to determine, when the failure has occurred, that the sub-processing device connected to a network is a processing destination that performs the predetermined processing.

8. An information processing system comprising: an information processing device; a sub-processing device; and a cloud server device including
a failure determination unit configured to determine whether or not a failure has occurred in the information processing device configured to perform predetermined processing on the basis of information obtained from a state information acquisition device, and
a processing destination determination unit configured to determine, when the failure has occurred, that the sub-processing device connected to a network is a processing destination that performs the predetermined processing.

9. The information processing system according to claim 6, comprising a plurality of information processing devices, each being configured to perform predetermined processing on the basis of information obtained from a state information acquisition device,
wherein, when a failure has occurred in at least one of the plurality of information processing devices, each being configured to perform the predetermined processing, the sub-processing device performs the predetermined processing which the at least one of the plurality of information processing devices is configured to perform.

10. The information processing system according to claim 6, comprising a redundant configuration including a protocol conversion device which converts a protocol for communication between the state information acquisition device and the information processing device to relay information obtained from the state information acquisition device.

11. The information processing system according to claim 6, wherein the information processing device includes:
an application device configured to perform application processing as the predetermined processing; and
a protocol conversion device configured to convert a protocol for communication with the state information acquisition device to relay information obtained from the state information acquisition device.

12.-18. (canceled)

19. The information processing system according to claim 7, comprising a plurality of information processing devices, each being configured to perform predetermined processing on the basis of information obtained from a state information acquisition device,
wherein, when a failure has occurred in at least one of the plurality of information processing devices, each being configured to perform the predetermined processing, the sub-processing device performs the predetermined processing which the at least one of the plurality of information processing devices is configured to perform.

20. The information processing system according to claim 8, comprising a plurality of information processing devices, each being configured to perform predetermined processing on the basis of information obtained from a state information acquisition device,
wherein, when a failure has occurred in at least one of the plurality of information processing devices, each being configured to perform the predetermined processing, the sub-processing device performs the predetermined processing which the at least one of the plurality of information processing devices is configured to perform.

21. The information processing system according to claim 7, comprising a redundant configuration including a protocol conversion device which converts a protocol for communication between the state information acquisition device and the information processing device to relay information obtained from the state information acquisition device.

22. The information processing system according to claim 8, comprising a redundant configuration including a protocol conversion device which converts a protocol for communication between the state information acquisition device and the information processing device to relay information obtained from the state information acquisition device.

23. The information processing system according to claim 6, wherein the predetermined processing is application processing.

24. The information processing system according to claim 7, wherein the predetermined processing is application processing.

25. The information processing system according to claim 8, wherein the predetermined processing is application processing.

26. The information processing system according to claim 6, wherein the sub-processing device connected to the network is positioned in a cloud layer of a cloud network and is connected to the cloud network which is the network.

27. The information processing system according to claim 7, wherein the sub-processing device connected to the network is positioned in a cloud layer of a cloud network and is connected to the cloud network which is the network.

28. The information processing system according to claim 8, wherein the sub-processing device connected to the network is positioned in a cloud layer of a cloud network and is connected to the cloud network which is the network.
